(19) United States
(12) Patent Application Publication
(10) Pub. No.: US 2018/0077878 A1
(43) Pub. Date: Mar. 22, 2018

(54) GROUNDCROWN, COMPOSTABLE PLANT CONTAINER AND ANIMAL DETERRENT

(71) Applicants: Patricia C. Sands, Arlington, VA (US); Mary M. Reidel, Arlington, VA (US); Sean M. Mauro, Arlington, VA (US)

(72) Inventors: Patricia C. Sands, Arlington, VA (US); Mary M. Reidel, Arlington, VA (US); Sean M. Mauro, Arlington, VA (US)

(21) Appl. No.: 15/706,615

(22) Filed: Sep. 15, 2017

Related U.S. Application Data
(60) Provisional application No. 62/495,479, filed on Sep. 16, 2016.

(51) Int. Cl. A01G 9/10; A01G 13/10

(52) U.S. Cl. CPC A01G 9/102; A01G 13/10

(57) ABSTRACT

A planter made of PLA, a compostable resin with an element of kelp or a natural fertilizer added in molding. The planter has a crown shaped top edge, the mild points of which serve as a deterrent to animals walking on or eating the plant. The planter has slotted sidewalls in the base area that serve as a vent for water flow and for root expansion when directly planted into the ground. The container body is composed of a 100% organic compostable material. The body can be formed as a blend of 30 to 50% organic plastic with the remaining portion being composed of compostable organic material.

### CROSS REFERENCE TO RELATED APPLICATIONS

This application claims the priority of Provisional Application No. 62/495,479 filed on Sep. 16, 2016. The entire disclosure of this provisional patent application is hereby incorporated by reference thereto, in its entirety.

### STATEMENT REGARDING FEDERALLY SPONSORED RESEARCH OR DEVELOPMENT

Not applicable.

### FIELD OF THE INVENTION

The present invention relates to compostable plant container with unique features that work to assist in plant water retention, animal deterrent and root growth.

### BACKGROUND OF THE INVENTION

It is a problem in the art to provide a durable PLA or organic material that has the look and feel of the typical plastic planter used by the industry.

It is also a problem in the art to provide a planter that will assist with plant success by providing nutrients, animal barrier and water management, and eliminate environmental waste.

### SUMMARY OF THE INVENTION

From the foregoing, it is seen that it is a problem in the art to provide a compostable planter made of durable PLA or organic material that will assist with plant success by providing an animal barrier and water management, and eliminate environmental waste. According to the present invention, a compostable planter is provided that combines several unique features that work to assist to water retention in plants, animal deterrent and root growth.

The compostable planter of the present invention combines several unique features that work to assist in water retention in plants, animal deterrent and root growth. The Ground Crown Compostable Planter does not need to be discarded. It will decompose in the garden instead. It will replace plastic pots in the garden industry. The Ground Crown I Compostable Planter will be used to grow plants. Plants will be sold in the Ground Crown Compostable Planter and directly put in the ground as it is compostable.

The Compostable Planter of the present invention is an eco-friendly solution to plastic waste in the garden industry. It also promotes plant success by way of animal deterrent and water management.

The Ground Crown I Compostable Planter is made with a durable PLA or organic material that has the look and feel of the typical plastic planter used by the industry. The Ground Crown I Compostable Planter will be what the garden industry uses to grow plants, what the retail partners use to sell plants in stores and will be what the end user puts directly into the ground. The Ground Crown I Compostable Planter will decompose within a season and will assist with plant success, by providing animal barrier, water management. It eliminates a large environmental waste.

The composition of the Ground Crown Compostable Planter as a feature and with the constraints of the art has an element of kelp and/or a natural fertilizer added to the material in molding. This would give a natural fertilizer as the plant grows in the ground.

Animal deterrent: The Ground Crown Compostable Planter has a crown on the top edge of the pot. The mild points serve as a deterrent to animals walking on or eating the plant.

The crown area is solid and is also a planting guide for how far the pot should be placed in the ground. When planted with the crown above ground, it serves as a water container that will be a reservoir for a growing plant.

The slotted sidewalls and or openings of the base area serve as a vent for water flow and for root expansion when directly planted into the ground.

The bottom area of the Ground Crown Compostable Planter is open so that the plant will not get waterlogged and will accommodate root expansion.

Other objects and advantages of the present invention will be more readily apparent from the following detailed description when read in conjunction with the accompanying drawings.

### BRIEF DESCRIPTION OF THE DRAWINGS

FIG. 1 is a front elevational view of a Ground Crown compostable plant container and animal deterrent, according to the present invention.

### DETAILED DESCRIPTION OF THE INVENTION

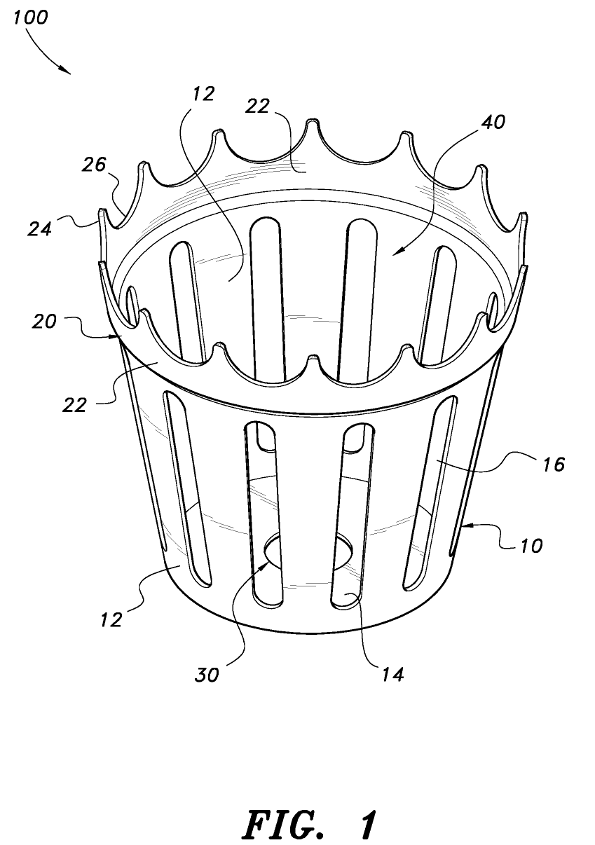

FIG. 1 is a front elevational view of a Ground Crown compostable plant container and animal deterrent 100 (hereafter referred to as “planter 100”) formed of PLA and compostable material. Here, the planter 100 has a container body which includes a base portion 10, a crown portion 20, and a bottom wall 14, and thereby forms an enclosure having an interior space 40.

The base portion 10 includes a side wall 12. The side wall 12 has a plurality of parallel, evenly spaced slots 16. The crown portion 20 has a side wall 22, a plurality of tips 24 and a plurality of recesses 26 separating the tips 24. The bottom wall 14 has an opening 30 therethrough to permit drainage.

The planter 100 of FIG. 1 in the preferred embodiment is composed of a mixture of PLA and organic material. The PLA is a compostable resin very much like plastic in appearance, which will allow the planter 100 to serve as a durable container for the life cycle of the plant and have the feature of decomposing in the ground. The planter 100 preferably includes a portion of kelp or a natural fertilizer added to the PLA material in the molding process. This would give a natural fertilizer as the plant grows in the ground.

PLA, poly or polylactic acid or polylactide, is a biodegradable and bioactive thermoplastic aliphatic polyester derived from renewable resources, such as corn starch, cassava roots, chips or starch, or sugarcane.

The openings 16 in the base portion 10 and the opening 30 of the bottom wall 14 serve as a vent for water flow so that the plant will not be waterlogged. These openings 15 and 30 will also accommodate root expansion when directly planted into the ground.

The Ground Crown I Compostable Planter serves to eliminate need for non-biodegradable plastic typically used for pots in the garden industry. The Ground Crown Compostable Planter of the present invention will, within a season in the ground, decompose into the soil. The garden industry will benefit from having a semi durable product that will be eco-friendly in the worldwide market. The Ground Crown Compostable Planter is attractive enough to use for the retail sales and durable for shelf life. The end user will have more success with their plants as it will assist with water retention, serves as an animal deterrent, and permits root growth with the benefit of natural fertilizer as the planter 100 decomposes. The Ground Crown Compostable Planter therefore leave no carbon footprint for the garden industry.

The container body is composed of 100% organic plastic material. This encompasses both Hemp Plastic and PLA, and contemplates all future materials that have properties similar to conventional molded plastics and which are also compostable and biodegradable. The thickness of the container body is relatively thin so as to facilitate composting, but is sufficiently thick so as to be sturdy enough to hold the plant during the growing/selling season. For example, container wall thicknesses are preferably in a range of 0.20 inches to 1.5 inches; thicknesses outside this range will also work. The preferred thickness in the preferred embodiment is one-eighth inch thickness.

The container body is composed preferably of a blend of 30 to 50% Organic Plastic (such as PLA or Hemp) with the remaining portion being composed of compostable organic material selected depending on the stability of the material used. Such compostable organic material would include paper, leaves, and other biodegradable compostable materials which would be known to any one having skill in the composting arts.

Materials suitable for forming the container 100 of the present invention would be a blend of polylatic acid (PLA) and polyhydroxalkanoate (PHA) and 50% to 25% Vinnex powder and or resin (vinyl acetate based homo-co- or terpolymers.) Vinnex has been known to blend with organic and inorganic fillers for tear resistance and stiffness. The supplier Wacker company (having a site wacker.com) has the technology and the art to produce this product.

As noted in the Wacker company site, biodegradation of TPS/PLA/VINNEX® blends under industrial composting conditions (ISO 14855 of EN 13432). On a relative basis with cellulose as the reference substrate, values of 90.0% and 90.1% were calculated. As such, the 90% biodegradability criterion was reached in 65 days both on an absolute and on a relative basis.

Types of materials include:

Bio plastic: polyhydroalkanoate, or PHA. PHAs; Bio based drop ins: bio-polyethylene (PE), bio-polypropylene (PP) and bio-polyethylene terephalate (PET);

Fossil fuel based plastics: polybutyrate (PBAT) and polycaprolactone (PCL);

Alternatively, hemp plastic materials are a suitable match for materials and molding.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. A compostable plant container for growing plants, comprising:
a container body having a base portion, a crown portion, and a bottom wall which together form an enclosure having an interior space;
said base portion having a plurality of slots adapted to facilitate drainage and to permit root growth of a plant growing in the container body;
said crown portion having a side wall, said side wall having a plurality of tips and a plurality of recesses respectively separating said tips, said crown portion being adapted to serve as an animal deterrent; and
said bottom wall having an opening therethrough to permit drainage;
said container body being composed of a mixture of PLA and compostable material.

2. A compostable planter as claimed in claim 1, wherein said container body is composed of a 100% organic compostable material. with a crown shaped top edge, the mild points serve as a deterrent to animals walking on or eating the plant.

3. A compostable planter as claimed in claim 1, wherein said container body is composed of a 100% organic compostable material, formed as a blend of 30 to 50% Organic Plastic with the remaining portion being composed of compostable organic material.

4. A compostable planter as claimed in claim 1, wherein said container body is composed of a 100% organic compostable material, formed as a blend of 30 to 50% Organic Plastic comprised of one of PLA and Hemp, and wherein the remaining portion is composed of compostable organic material.

5. A compostable plant container for growing plants, comprising:
a container body having a base portion, a crown portion, and a bottom wall which together form an enclosure having an interior space;
said crown portion having a side wall, said side wall having a plurality of tips and a plurality of recesses respectively separating said tips, said crown portion being adapted to serve as an animal deterrent; and
said bottom wall having an opening therethrough to permit drainage;
said container body being composed of a mixture of PLA and compostable material.

6. A compostable planter as claimed in claim 1, wherein said container body is composed of a 100% organic compostable material. with a crown shaped top edge, the mild points serve as a deterrent to animals walking on or eating the plant.

7. A compostable planter as claimed in claim 1, wherein said container body is composed of a 100% organic compostable material, formed as a blend of 30 to 50% Organic Plastic with the remaining portion being composed of compostable organic material.

8. A compostable planter as claimed in claim 1, wherein said container body is composed of a 100% organic compostable material, formed as a blend of 30 to 50% Organic Plastic comprised of one of PLA and Hemp, and wherein the remaining portion is composed of compostable organic material.
